(19) United States
(12) Patent Application Publication
(10) Pub. No.: US 2026/0003378 A1
(43) Pub. Date: Jan. 1, 2026

(54) CURRENT-TO-VOLTAGE CONVERSION CIRCUIT AND DIGITAL ISOLATOR

(71) Applicant: SUZHOU NOVOSENSE MICROELECTRONICS CO., LTD., Suzhou City (CN)

(72) Inventors: Jia JIANG, Suzhou City (CN); Qihui CHEN, Suzhou City (CN); Xiaolei GUO, Suzhou City (CN); Yuanjie SUN, Suzhou City (CN)

(21) Appl. No.: 19/217,157

(22) Filed: May 23, 2025

(30) Foreign Application Priority Data
May 27, 2024 (CN) 202410666776.0

(51) Int. Cl. G05F 1/56

(52) U.S. Cl. CPC G05F 1/561

(57) ABSTRACT

A current-to-voltage conversion circuit used in a digital isolator. The current-to-voltage conversion circuit has an input terminal to receive an input current, an output terminal to output a power supply voltage generated based on the input current. The current-to-voltage conversion circuit has an operational amplifier and a voltage regulation switch device, the voltage regulation switch device has a control end coupled to an output end of the operational amplifier. When the input current is less than an adjustment threshold, the voltage regulation switch device is turned off, and when the input current is greater than the adjustment threshold, the voltage regulation switch device is turned on.

### CROSS-REFERENCE TO RELATED APPLICATIONS

This application claims priority to Chinese Patent Application No. 202410666776.0, filed with the China National Intellectual Property Administration on May 27, 2024 and entitled “CURRENT-TO-VOLTAGE CONVERSION CIRCUIT AND DIGITAL ISOLATOR”, which is incorporated herein by reference in its entirety.

### TECHNICAL FIELD

This application relates to the technical field of electronic circuit, and more specifically, to a current-to-voltage conversion circuit and a digital isolator.

### BACKGROUND

A digital isolator based on OOK (on-off keying) modulation generally comprises a current-to-voltage conversion circuit. The working principle of the digital isolator is: when an input terminal has an input current, the current-to-voltage conversion circuit generates a power supply voltage according to the input current to supply power to a transmitting circuit. The transmitting circuit works and sends a high-frequency carrier signal. After being attenuated by the isolation barrier, the high-frequency carrier signal is received and processed by a receiving circuit, and a corresponding output voltage VO is outputted, thereby achieving isolated signal transmission.

### SUMMARY

The power supply voltage is closely related to the frequency of the high-frequency carrier signal, a change in the power supply voltage may cause a change in the frequency of the high-frequency carrier signal, thereby affecting the normal operation of the digital isolator.

The present application provides a current-to-voltage conversion circuit, comprising: an input terminal, configured to receive an input current; an output terminal, configured to output a power supply voltage; a voltage generation circuit having an input end and an output end, wherein the input end of the voltage generation circuit is coupled to the input terminal of the current-to-voltage conversion circuit so as to receive the input current and generate the power supply voltage according to the input current; and a voltage regulation circuit, comprising an operational amplifier and a voltage regulation switch device, a control end of the voltage regulation switch device is coupled to an output end of the operational amplifier; when the input current is less than an adjustment threshold, the voltage regulation switch device is turned off; and when the input current is greater than the adjustment threshold, the voltage regulation switch device is turned on.

The present application also provides a digital isolator, comprising: a current-to-voltage conversion circuit, a transmitting circuit configured to generate a transmitting signal according to a power supply voltage; an isolation circuit configured to generate a receiving signal according to the transmitting signal; a receiving circuit configured to generate an output voltage according to the receiving signal; wherein the frequency of the transmitting signal is equal to the frequency of the receiving signal. The current-to-voltage conversion circuit comprises a input terminal configured to receive an input current; an output terminal configured to output a power supply voltage; a voltage generation circuit having an input end and an output end, the input end of the voltage generation circuit is coupled to the input terminal of the current-to-voltage conversion circuit so as to receive the input current and generate the power supply voltage according to the input current; and a voltage regulation circuit, comprising an operational amplifier and a voltage regulation switch device, a control end of the voltage regulation switch device is coupled to the output end of the operational amplifier; when the input current is less than an adjustment threshold, the voltage regulation switch device is turned off; and when the input current is greater than the adjustment threshold, the voltage regulation switch device is turned on.

### TECHNICAL EFFECT

The current-to-voltage conversion circuit of the present application can generate a high-precision voltage by using MOS transistors (such as M1 and M2) working in a sub-threshold region, and such a voltage is relatively insensitive to temperature and process variations. The MOS transistor operating in the sub-threshold region refers to that an operating state of the MOS transistor is in a low voltage state, which is close to or slightly lower than a threshold voltage of the MOS transistor. In this state, the characteristics of the MOS transistor become more stable, and the response is more linear, thereby achieving higher accuracy. By using the MOS transistor structure working in the sub-threshold region, the designed current-to-voltage conversion circuit can generate a high-precision voltage output. Since such a circuit has less impact on temperature and process variations, stable performance can be maintained in different operating environments. Such high-precision voltage output is important for many applications requiring stable voltage.

Secondly, the current-to-voltage conversion circuit has high precision, is less affected by temperature, process and the input current, and has enhanced stability and reliability, thereby improving transmission reliability of a digital isolator using the current-to-voltage conversion circuit.

Further, a power supply voltage Vreg of the current-to-voltage conversion circuit is established at a high speed, which can improve a transmission speed of the digital isolator. Because a part of the transmission delay comes from the set-up delay of the TX circuit of the digital isolator, by using the current-to-voltage conversion circuit with a faster set-up speed, the transmission speed of the digital isolator to which the current-to-voltage conversion circuit is applied can be improved.

### BRIEF DESCRIPTION OF THE DRAWINGS

To describe technical solutions in embodiments of this application more clearly, the following briefly introduces the accompanying drawings for describing the embodiments. It is apparent that the accompanying drawings in the following descriptions show merely some embodiments of this application, and a person skilled in the art may still derive other drawings from these accompanying drawings without creative efforts.

FIG. 1 is a schematic circuit diagram of a typical existing digital isolator 100;

FIG. 2 is a waveform diagram of each signal during the operation of the digital isolator 100 shown in FIG. 1;

FIG. 3 is a schematic diagram of a frequency range of normal demodulation and a frequency range of abnormal demodulation for the digital isolator;

FIG. 4 is a circuit diagram of a current-to-voltage conversion circuit 400 according to an embodiment of the present application;

FIG. 5 is a waveform diagram of the power supply voltage Vreg in the current-to-voltage conversion circuit 400 shown in FIG. 4;

FIG. 6 is a schematic circuit diagram of a current-to-voltage conversion circuit 600 according to another embodiment of the present application;

FIG. 7 shows waveforms of power supply voltages Vreg in the current-to-voltage conversion circuit 400 shown in FIG. 4 as well as in the current-to-voltage conversion circuit 600 shown in FIG. 6;

FIG. 8 is a circuit diagram of a current-to-voltage conversion circuit 800 according to another embodiment of the present application;

FIG. 9 is a circuit diagram of a current-to-voltage conversion circuit 900 according to a further embodiment of the present application.

### DETAILED DESCRIPTION

The following clearly and completely describes the technical solutions in the embodiments of this application with reference to the accompanying drawing of the embodiments of this application. It is apparent that the described embodiments are merely some samples, not all of embodiments of this application. All other embodiments obtained by a person skilled in the art based on the embodiments of this application without creative efforts shall fall within the protection scope of this application.

In the description of the present application, it should be noted that, throughout the description and claims, “coupled” is defined as directly or indirectly connecting in an electrical or non-electrical manner. When an element is described as being “connected” or “coupled” to another element, it can be directly connected or coupled to the other element, or one or more intervening elements may be present. In contrast, when an element is described as being “directly connected” or “directly coupled” to another element, there are no intervening elements present. Reference throughout this description to “one embodiment”, “an embodiment”, “one example” or “an example” means: the specific features, structures, or characteristics described in conjunction with that embodiment or example are included in at least one embodiment of the present application. Thus, the appearances of the phrases “in one embodiment”, “in an embodiment”, “one example” or “an example” in various places throughout this description are not necessarily all referring to the same embodiment or example. Furthermore, a particular feature, structure, or characteristic may be combined in any suitable combination and/or sub-combination in one or more embodiments or examples. Furthermore, it will be understood by those of ordinary skill in the art that the figures provided herein are for illustrative purposes and that the figures are not necessarily drawn to scale. The same reference numbers refer to the same devices. The term “and/or” as used herein includes any and all combinations of one or more of the associated listed items.

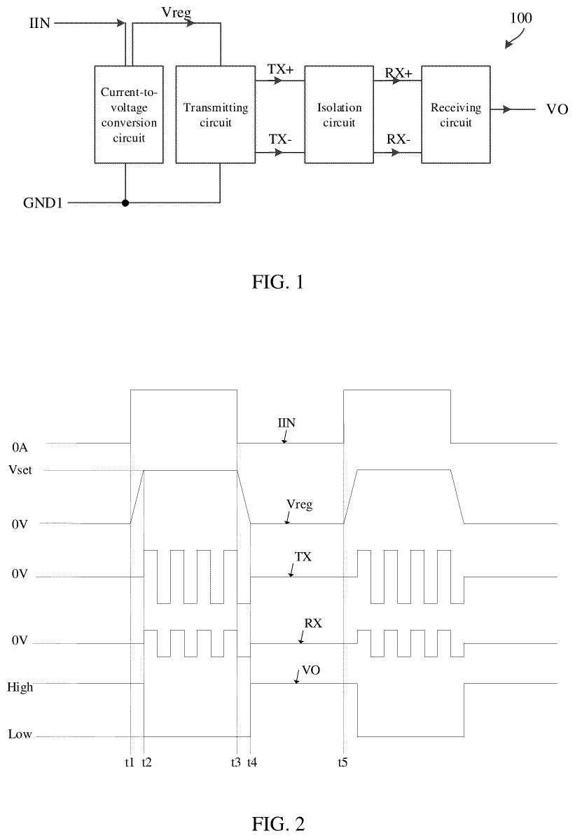

FIG. 1 is a schematic circuit diagram of a prior art digital isolator 100. The digital isolator 100 comprises a current-to-voltage conversion circuit, a transmitting circuit, an isolation circuit, and a receiving circuit. The current-to-voltage conversion circuit receives an input current IIN, and generates a power supply voltage Vreg according to the input current IIN to supply power to the transmitting circuit. The transmitting circuit generates a transmitting signal TX according to the power supply voltage Vreg. The transmitting signal TX usually comprises a first transmitting signal TX+ and a second transmitting signal TX−. The first transmitting signal TX+ and the second transmitting signal TX-pass through an isolation circuit to generate the first receiving signal RX+ and the second receiving signal RX−, the first receiving signal RX+ and the first transmitting signal TX+ have the same frequency, and an amplitude of the first receiving signal RX+ is less than that of the first transmitting signal TX+. The receiving circuit receives the first receiving signal RX+ and the second receiving signal RX−, and generates an output voltage VO according to the first receiving signal RX+ and the second receiving signal RX−. For the transmitting circuit, a change in the power supply voltage Vreg influences the frequencies of the first transmitting signal TX+ and a second transmitting signal TX−. Specifically, the frequencies of the first transmitting signal TX+ and the second transmitting signal TX− are decreased with the decrease of power supply voltage Vreg, the frequencies of the first transmitting signal TX+ and the second transmitting signal TX− are increased with the increase of the power supply voltage Vreg. That is, the frequencies of the first transmitting signal TX+ and the second transmitting signal TX− are determined by the power supply voltage Vreg. The digital isolator 100 operates in a first operation mode or a second operation mode respectively according to the input current IIN. The operating principle thereof is as follows:

The first operation mode: when the input current IIN is less than an operation preset value, the power supply voltage Vreg is zero. At this time, the first transmitting signal TX+ and the second transmitting signal TX− are at a low logic level, and at this time, the output voltage VO of the receiving circuit is at a high logic level.

The second operation mode: when the input current IIN is greater than the operation preset value, the power supply voltage Vreg is powered to the transmitting circuit. The transmitting signal TX is a pulse width modulation signal. The transmitting signal TX is transmitted by the isolation circuit, and at this time, the output voltage VO is at a low logic level.

FIG. 2 is a waveform diagram of each signal during the operation of the digital isolator 100 shown in FIG. 1. The waveform of each signal in FIG. 2 is described with reference to the digital isolator 100 in FIG. 1. It can be seen from FIG. 2 that at the moment t1, the input current IIN transmits from 0 A to a certain current value (which is greater than the operation preset value), the power supply voltage Vreg rapidly rises, and at the moment t2, the power supply voltage Vreg rises to the output preset value Vset. From time t2 to time t3, the transmitting signal TX is a pulse width modulation signal, and a receiving signal RX is also a pulse width modulation signal, in which the amplitude of the receiving signal RX is less than the amplitude of the transmitting signal TX, and from time t2 to time t3, the output voltage VO is in a low logic level. At time t3, the input current IIN transmits from the certain current value (greater than the operation preset value) to 0 A. Therefore, the power supply voltage Vreg decreases from time t3, and decreases to 0V at time t4. From time t4 to time t5, the transmitting signal TX and the receiving signal RX are 0V, and are no longer pulse width modulation signals. From time t4 to time t5, the output voltage VO is at a high logic level.

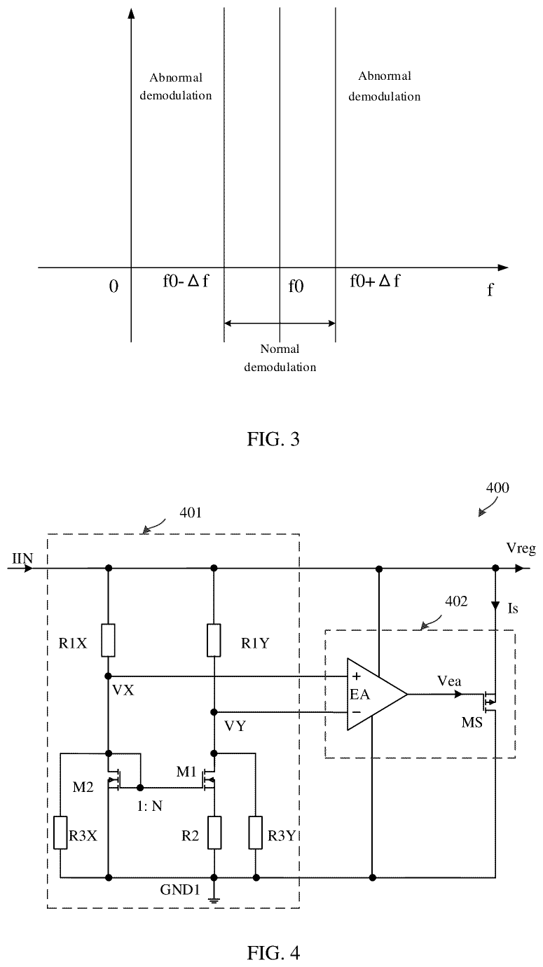

FIG. 3 illustrates a frequency range of normal demodulation and abnormal demodulation for the digital isolator. Generally, in order to ensure an anti-noise interference capability of the digital isolator, the receiving circuit has a band-pass demodulation characteristic. Only when the receiving signal RX is near a band-pass frequency f0, the receiving circuit can demodulate the receiving signal RX. And when the frequency of the receiving signal RX is not near the band-pass frequency f0, the receiving circuit cannot demodulate the receiving signal RX, and abnormal demodulation occurs. That is, as shown in FIG. 3, when the frequency of the receiving signal RX is between f0−Δf and f0+Δf, the receiving circuit can normally demodulate the receiving signal RX. And when the frequency of the receiving signal RX is less than f0−Δf or greater than f0+Δf, the receiving circuit cannot normally demodulate the receiving signal RX. When a variation range of the power supply voltage Vreg is large, a frequency range of the receiving signal RX received by the receiving circuit is also large. The receiving signal with an excessively high frequency or an excessively low frequency may cause an abnormal demodulation, and finally affect the accuracy of an output level of the digital isolator, thereby causing an erroneous output. Typically, the band-pass frequency is between 250 MHz and 300 MHz.

Therefore, in an actual circuit design, in order to ensure normal operation of the digital isolator, the power supply voltage Vreg needs to be kept constant, so as to maintain stability of frequencies of the transmitting signal TX and the receiving signal RX. That is, for the current-to-voltage circuit, when the input current IIN varies within a certain range, such as between 2 mA and 20 mA, and the temperature varies within a certain range, such as between −40° C. and 150° C. per Automotive Grade, between −40° C. and 125° C. per Industrial Grade, the power supply voltage Vreg is desired to be relatively constant.

FIG. 4 is a circuit diagram of a current-to-voltage conversion circuit 400 according to an embodiment of the present application. The current-to-voltage conversion circuit 400 has an input terminal, an output terminal, a voltage generation circuit 401, and a voltage regulation unit 402. The input terminal is configured to receive an input current IIN, and the output terminal is configured to output a power supply voltage Vreg. The voltage generation circuit 401 has an input end and an output end, the input end of the voltage generation circuit 401 is configured to receive the input current IIN. The voltage generation circuit 401 is configured to generate the power supply voltage Vreg based on the input current IIN and outputs it at the output end. The voltage regulation unit 402 comprises an operational amplifier EA and a voltage regulation switch device MS, an output end of the operational amplifier EA outputs an error signal Vea to a control end of the voltage regulation switch device MS. When the input current IIN is smaller than a adjustment threshold Ith, the voltage regulation switch device MS is turned off. When the input current IIN is greater than the adjustment threshold Ith, the voltage regulation switch device MS is turned on, and a regulated current Is flows through the voltage regulation switch device MS, and the regulated current Is is not 0 A.

In the embodiment shown in FIG. 4, the voltage generation circuit 401 comprises a first resistor R1X, a second resistor R1Y, a first transistor M1, a second transistor M2, a third resistor R3X, a fourth resistor R3Y, and a fifth resistor R2. The first resistor R1X has a first end and a second end, the first end of the first resistor R1X is coupled to the input end of the voltage generation circuit 401 to receive the input current IIN. The second resistor R1Y has a first end and a second end, the first end of the second resistor R1Y is coupled to the input end of the voltage generation circuit 401 to receive the input current IIN. The third resistor R3X has a first end and a second end, the first end of the third resistor R3X is coupled to the second end of the first resistor R1X, the second end of the third resistor R3X is coupled to a reference ground GND1. The fourth resistor R3Y has a first end and a second end, the first end of the fourth resistor R3Y is coupled to the second end of the second resistor R1Y, the second end of the fourth resistor R3Y is coupled to the reference ground GND1. The fifth resistor R2 has a first end and a second end, the second end of the fifth resistor R2 is coupled to the reference ground GND1. A drain end of the first transistor M1 is coupled to the second end of the second resistor R1Y, and a source end of the first transistor M1 is coupled to the first end of the fifth resistor R2. A gate end of the second transistor M2 is coupled to a gate end of the first transistor M1, a drain end of the second transistor M2 is coupled to the gate end of the second transistor M2 and the second end of the first resistor R1X, and a source end of the second transistor M2 is coupled to the reference ground GND1. In one embodiment, a resistance of the first resistor R1X is equal to a resistance of the second resistor R1Y. In one embodiment, the resistance of the first resistor R1X ranges from 5KΩ to 20KΩ. In the embodiment shown in FIG. 4, the adjustment threshold Ith is related to the resistance of first resistor RIX. In one embodiment, the adjustment threshold Ith is between 100 μA and 300 μA.

The current-to-voltage conversion circuit 400 shown in FIG. 4 has the following working procedures when it is started:

In a first stage, the power supply voltage Vreg is less than an operating voltage of the operational amplifier EA. For example, the power supply voltage Vreg is less than 1V. The operational amplifier EA does not function, the voltage regulation switch device MS is in an off state, and the power supply voltage Vreg increases over time.

In a second stage, the power supply voltage Vreg is greater than the operating voltage of the operational amplifier EA, and lower than an output preset value Vset, a current flowing through the first transistor M1 is greater than a current flowing through the second transistor M2, and a first voltage VX is greater than a second voltage VY. In theory, the error signal Vea of the operational amplifier EA is at a high logic level, but the slew rate of the operational amplifier EA is limited. However, due to the limited slew rate of the operational amplifier EA and the fact that there is usually a large parasitic capacitance at the gate end of the voltage regulation switch device MS, the potential at the gate end of the voltage regulation switch device MS is less than the power supply voltage Vreg, and the voltage at the gate end of the voltage regulation switch device MS is always lower than the voltage at the source end. That is, the error signal Vea output by the operational amplifier EA is always lower than the power supply voltage Vreg, the voltage regulation switch device MS is turned on, the regulated current Is is non-zero, and a charging speed of the power supply voltage Vreg slows down.

In a third stage, the input current IIN is greater than the adjustment threshold Ith. The voltage regulation switch device MS is controlled to turn on by the operational amplifier EA, and the magnitude of the regulated current Is is adjusted. The power supply voltage Vreg is adjusted at the output preset value Vset by the operational amplifier EA Also.

With a virtual short characteristic of the operational amplifier EA, the first voltage VX is equal to the second voltage VY, VX=VY=VGS2 (VGS2 is the gate-source voltage of the second transistor M2), and the currents flowing through the first transistor M1 and the second transistor M2 are equal in this way. The power supply voltage Vreg is determined by the following formula (1), where the power supply voltage Vreg is:

$$Vreg = \frac{R 1 X / R 1 Y}{R 2} \times ( VGS 2 - VGS 1 ) + ( 1 + \frac{R 1 X}{\frac{R 1 Y}{\frac{R 3 X}{R 3 Y}}} ) \times VGS 2 = \frac{R 1 X}{\frac{R 1 Y}{R 2}} \times VT ln N + ( 1 + \frac{R 1 X / R 1 Y}{R 3 X / R 3 Y} ) \times VGS 2 \qquad ( 1 )$$

In the above formula, R1X represents a resistance value of the first resistor R1X, and R1Y represents a resistance value of the second resistor R1Y. Similarly, R3X represents a resistance value of the third resistor R3X, R3Y represents a resistance value of the fourth resistor R3Y, N is a ratio coefficient which represents a size ratio of the second transistor M2 to the first transistor M1, VT represents a thermal voltage, VGS2 represents the gate-source voltage of the second transistor M2, and VGS1 represents a gate-source voltage of the first transistor M1.

When the second transistor M2 is in the subthreshold region, the gate-source voltage of the second transistor VGS2 decreases as the temperature increases. The thermal voltage VT is a positive temperature coefficient, that is, the thermal voltage VT increases with the increase of the temperature. Therefore, the power supply voltage Vreg can be kept substantially unchanged with the change of the temperature by adjusting the ratios between the first resistor R1X and the second resistor R2Y as well as between the third resistor R3X and the fourth resistor R3Y, and the ratio coefficient N. For example, it is relatively easy to reduce the temperature characteristics of the power supply voltage Vreg to 0.3 millivolts per degree Celsius (0.3 mV/C) by reasonably setting the ratios of resistances and the proportional system.

Therefore, according to the circuit design shown in FIG. 4, the current-to-voltage conversion circuit 400 can generate the power supply voltage Vreg with high accuracy, which is less responsive to changes in the input current IIN, temperature and process. That is, the current-to-voltage conversion circuit 400 shown in FIG. 4 can maintain the stability and accuracy of the power supply voltage Vreg under the conditions of variations in the input current IIN, temperature, and process.

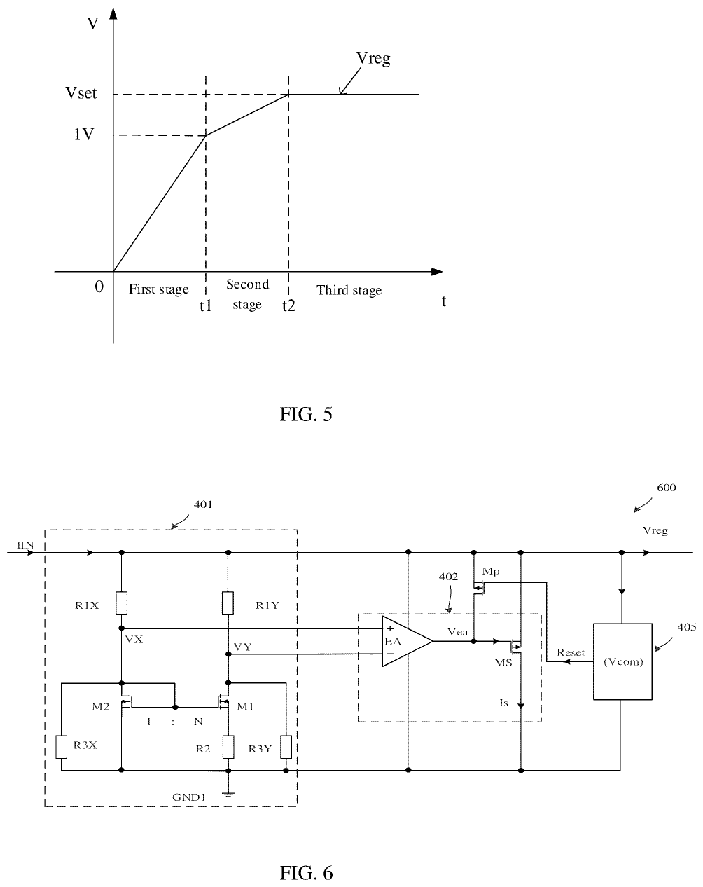

FIG. 5 is a waveform diagram of the power supply voltage Vreg in the current-to-voltage conversion circuit 400 shown in FIG. 4. Assume that the power supply voltage Vreg has an output preset value Vset, the power supply voltage Vreg will start up with the first stage, the second stage, and the third stage.

In the first stage, the power supply voltage Vreg increases rapidly, until the power supply voltage Vreg increases to, for example, 1V. the operational amplifier EA starts to operate, the voltage regulation switch device MS is turned on and the current-to-voltage conversion circuit enters to work in the second stage. In the second stage, since the voltage regulation switch device MS is turned on, the regulated current Is is not zero, and the increasing rate of the power supply voltage Vreg decreases. The power supply voltage Vreg is increased until the power supply voltage Vreg is equal to the output preset value Vset and the current-to-voltage conversion circuit enters to work in the third stage. In the third stage, the power supply voltage Vreg is maintained at the output preset value Vset.

FIG. 6 is a schematic circuit diagram of a current-to-voltage conversion circuit 600 according to another embodiment of the present application. Compared with the current-to-voltage conversion circuit 400 shown in FIG. 4, the current-to-voltage conversion circuit 600 further comprises a power supply monitoring circuit 405 and a monitoring switch device Mp. A first end of the power supply monitoring circuit 405 is coupled to an output terminal OUT of the current-to-voltage conversion circuit 600 so as to receive the power supply voltage Vreg, and a second end of the power supply monitoring circuit 405 outputs a reset signal Reset. The monitoring switch device Mp has a first end, a second end and a third end, the first end thereof receives the reset signal Reset, the second end thereof is coupled to the output terminal of the current-to-voltage conversion circuit 600, and the third end thereof is coupled to the output end of the operational amplifier EA. In the embodiment shown in FIG. 6, the monitoring switch device Mp is a P-type field-effect transistor, the drain end of the monitoring switch device Mp is coupled to the output end of the operational amplifier EA to receive the error signal Vea, and the source end of the monitoring switch device Mp is coupled to the output terminal of the current-to-voltage conversion circuit 600. The power supply monitoring circuit 405 detects the power supply voltage Vreg, and generates the reset signal Reset according to the power supply voltage Vreg to control on or off of the monitoring switch device Mp. More specifically, when the voltage of the power supply voltage Vreg is lower than a comparison threshold Vcom, the reset signal Reset is at a low logic level, the monitoring switch device Mp is turned on, the error signal Vea is pulled up to the power supply voltage Vreg, the voltage regulation switch device MS is turned off, the regulated current Is is zero, and the power supply voltage Vreg is quickly established. When the power supply voltage Vreg is higher than the comparison threshold Vcom, the reset signal Reset is at a high logic level, the monitoring switch device Mp is turned off, the error signal Vea controls the voltage regulation switch device MS to be turned on, and the regulated current Is is not zero. The feedback loop starts to work normally, and adjusts the voltage of the power supply voltage Vreg to a stable value. In an embodiment, the comparison threshold Vcom may be set as from 80%×Vset to 95%×Vset, so as to greatly reduce the time of the second stage described in FIG. 5. By setting the comparison threshold Vcom close to the output preset value Vset, the power supply voltage Vreg can be adjusted to a steady state more quickly, thereby improving the speed of establishing the power supply voltage Vreg.

In conclusion, the power supply monitoring circuit 405 monitors the power supply voltage Vreg, and controls on and off of the monitoring switch device Mp according to the power supply voltage Vreg, so as to achieve stable control over the power supply voltage Vreg. By adjusting the comparison threshold Vcom, the establishing speed of the power supply voltage Vreg can be optimized, so as to enable it to reach a stable state more quickly.

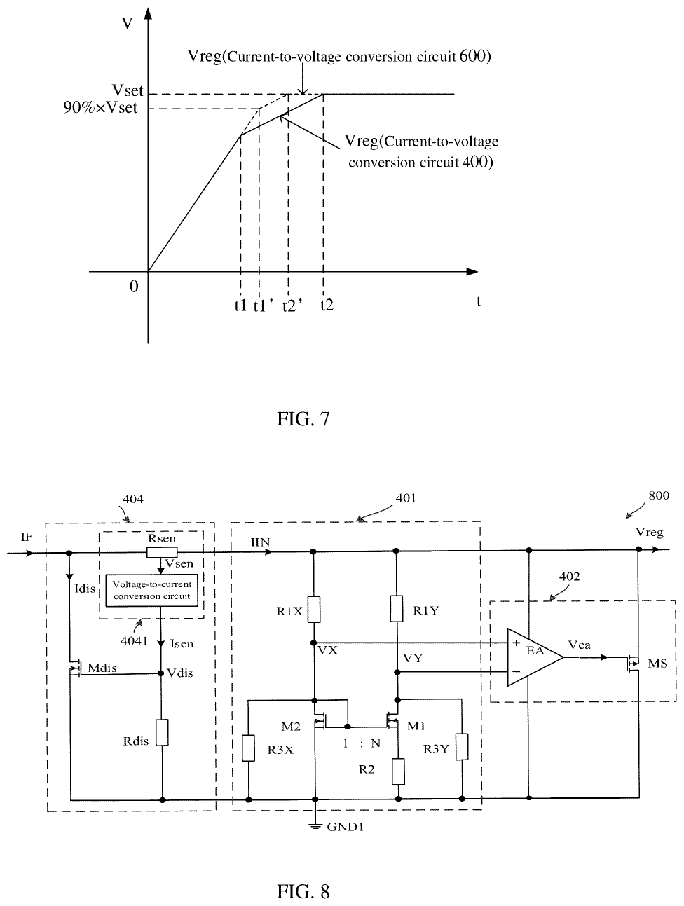

FIG. 7 shows startup waveforms of power supply voltages Vreg in the current-to-voltage conversion circuit 400 shown in FIG. 4 as well as in the current-to-voltage conversion circuit 600 shown in FIG. 6. For the current-to-voltage conversion circuit 400, starting from time t1, the voltage regulation switch device MS is turned on, the regulated current Is is not zero, and the power supply voltage Vreg takes a relatively long time (from time t1 to time t2) to reach the output preset value Vset. For the current-to-voltage conversion circuit 600, when the comparison threshold is set to 90%×Vset, at time t1, the voltage regulation switch device MS in the current-to-voltage conversion circuit 600 is not turned on, the regulated current Is is zero, and the power supply voltage Vreg rises rapidly. At time t1′, the power supply voltage Vreg rises to 90%×Vset, the voltage regulation switch device MS in the current-to-voltage conversion circuit 600 is turned on, and the regulated current Is is non-zero. At time t2′, the power supply voltage Vreg rises to the output preset value Vset. From FIG. 7, it can be seen that the time required to start the power supply voltage Vreg in the current-to-voltage conversion circuit 600 is shorter.

FIG. 8 is a circuit diagram of a current-to-voltage conversion circuit 800 according to another embodiment of the present application. Compared with the current-to-voltage conversion circuit 400 shown in FIG. 4, the current-to-voltage conversion circuit 800 further comprises a current management circuit 404. The current management circuit 404 has a current detection circuit 4041, a current control transistor Mdis, and a current control resistor Rdis. The current management circuit 404 has an input end to receive a front-end current IF, and an output end to provide the input current IIN. The current detection circuit 4041 has an input end, a first output end and a second output end, in which the input end of the current detection circuit 4041 is coupled to the input end of the current management circuit 404, the first output end is coupled to the output terminal of the current-to-voltage conversion circuit 800 so as to provide the input current IIN, and the second output end outputs a current detection signal Isen, the current detection signal Isen represents the magnitude of a current flowing through the current detection circuit 4041. In the embodiment shown in FIG. 8, the current detection circuit 4041 comprises a detection resistor Rsen and a voltage-to-current conversion circuit, a first end of the detection resistor Rsen is coupled to the input end of the current management circuit 404, a second end of the detection resistor Rsen is coupled to the output end of the current management circuit 404, and a voltage across the detection resistor Rsen is a detection voltage Vsen. The voltage-to-current conversion circuit receives the detection voltage Vsen, and generates the current detection signal Isen according to the detection voltage Vsen. A first end of the current control resistor Rdis receives the current detection signal Isen, and a second terminal of the current control resistor Rdis is coupled to the reference ground GND1. A drain end of the current control transistor Mdis is coupled to the input end of the current management circuit 404, a source end of the current control transistor Mdis is coupled to the reference ground GND1, and a gate end of the current control transistor Mdis is coupled to the first end of the current control resistor Rdis.

When the front-end current IF is smaller than a front-end threshold Fth, the detection voltage Vsen across the two ends of the detection resistor Rsen is relatively small, and the current detection signal Isen generated according to the detection voltage Vsen is also relatively small. A discharge voltage Vdis generated by the current detection signal Isen flowing through the current control resistor Rdis is relatively low, and the discharge voltage Vdis is less than the voltage threshold required for the current control transistor Mdis to be turned on; therefore, the current control transistor Mdis is in the off state, and it can be obtained that the input current IIN is equal to the front-end current IF. When the front-end current IF is greater than the front-end threshold Fth, the discharge voltage Vdis reaches the voltage threshold of the current control transistor Mdis, The current control transistor Mdis is turned on, a current flowing through the current control transistor Mdis is the adjustment current Idis, and therefore IIN=IF−Idis. Since the input current IIN is only a part of the front-end current IF, the voltage regulation switch device MS can adjust the power supply voltage Vreg to keep at the output preset value Vset with only a small size. In the embodiment shown in FIG. 8, the front-end threshold Fth is related to the resistance value of the current control resistor Rdis.

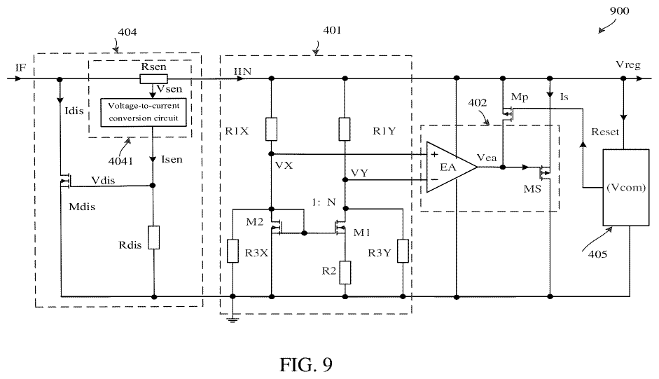

FIG. 9 is a circuit diagram of a current-to-voltage conversion circuit 900 according to a further embodiment of the present application. Compared with the current-to-voltage conversion circuit 400 shown in FIG. 4, the current-to-voltage conversion circuit 900 further comprises the current management circuit 404, the power supply monitoring circuit 405, and the monitoring switch device Mp. The structure of the current management circuit 404 is the same as that of the current management circuit in the embodiment of the current-to-voltage conversion circuit 800 shown in FIG. 8, and the functions thereof are the same. The power supply monitoring circuit 405 and the monitoring switch device Mp are the same with those described regarding the embodiment of the current-to-voltage conversion circuit 600 shown in FIG. 6 in the structure and the functions.

In conclusion, the current-to-voltage conversion circuit of the present application can generate a high-precision voltage by using MOS transistors (such as M1 and M2) working in a sub-threshold region, and such a voltage is relatively insensitive to temperature and process variations. The MOS transistor operating in the sub-threshold region refers to that an operating state of the MOS transistor is in a low voltage state, which is close to or slightly lower than a threshold voltage of the MOS transistor. In this state, the characteristics of the MOS transistor become more stable, and the response is more linear, thereby achieving higher accuracy. By using the MOS transistor structure working in the sub-threshold region, the designed current-to-voltage conversion circuit can generate a high-precision voltage output. Since such a circuit has less impact on temperature and process variations, stable performance can be maintained in different operating environments. Such high-precision voltage output is important for many applications requiring stable voltage.

Secondly, the current-to-voltage conversion circuit has high precision, is less affected by temperature, process and the input current, and has enhanced stability and reliability, thereby improving transmission reliability of a digital isolator using the current-to-voltage conversion circuit.

Further, the power supply voltage Vreg of the current-to-voltage conversion circuit is established at a high speed, which can improve a transmission speed of the digital isolator. Because a part of the transmission delay comes from the set-up delay of the TX circuit of the digital isolator, by using the current-to-voltage conversion circuit with a faster set-up speed, the transmission speed of the digital isolator to which the current-to-voltage conversion circuit is applied can be improved.

Specifically, an electronic device is internally integrated with the current-to-voltage conversion circuit, so as to ensure that the electronic device can obtain a stable voltage supply under various working conditions.

Therefore, to meet the requirements of stability and accuracy, it is necessary to design a high-precision current-to-voltage circuit whose output voltage is minimally affected by the input current, temperature, and process. This current-to-voltage circuit can convert the input current into a stable output voltage for use by the transmitting circuit.

Although the present application has been described with reference to several typical embodiments, it should be understood that the terms used are illustrative and exemplary rather than restrictive. Since the present application can be embodied in various forms without departing from the spirit or essence of the invention, it should be understood that the above-mentioned embodiments are not limited to any of the foregoing details, but should be broadly construed within the spirit and scope defined by the appended claims. Therefore, all changes and modifications that fall within the scope of the claims or their equivalents shall be covered by the appended claims.

1. A current-to-voltage conversion circuit used in a digital isolator, comprising:
an input terminal, configured to receive an input current;
an output terminal, configured to output a power supply voltage;
a voltage generation circuit having an input end and an output end, wherein the input end of the voltage generation circuit is coupled to the input terminal of the current-to-voltage conversion circuit so as to receive the input current and generate the power supply voltage according to the input current; and
a voltage regulation circuit, comprising an operational amplifier and a voltage regulation switch device, wherein a control end of the voltage regulation switch device is coupled to an output end of the operational amplifier;
wherein when the input current is less than an adjustment threshold, the voltage regulation switch device is turned off; and when the input current is greater than the adjustment threshold, the voltage regulation switch device is turned on.

2. The current-to-voltage conversion circuit according to claim 1, the voltage generation circuit comprising:
a first resistor having a first end and a second end, the first end of the first resistor is coupled to the input end of the voltage generation circuit to receive the input current;
a second resistor having a first end and a second end, the first end of the second resistor is coupled to the input end of the voltage generation circuit to receive the input current;
a third resistor having a first end and a second end, the first end of the third resistor is coupled to the second end of the first resistor, the second end of the third resistor is coupled to a reference ground;
a fourth resistor having a first end and a second end, the first end of the fourth resistor is coupled to the second end of the second resistor, the second end of the fourth resistor is coupled to the reference ground;
a fifth resistor having a first end and a second end, the second end of the fifth resistor is coupled to the reference ground;
a first transistor, wherein a drain end of the first transistor is coupled to the second end of the second resistor, and a source end of the first transistor is coupled to the first end of the fifth resistor; and
a second transistor, a gate end of the second transistor is coupled to a gate end of the first transistor, a drain end of the second transistor is coupled to the gate end of the second transistor and the second end of the first resistor, and a source end of the second transistor is coupled to the reference ground.

3. The current-to-voltage conversion circuit according to claim 2, wherein the adjustment threshold is related to the resistance of the first resistor.

4. The current-to-voltage conversion circuit according to claim 1, wherein the power supply voltage is between 1.2V and 2V.

5. The current-to-voltage conversion circuit according to claim 1, further comprising:
a power supply monitoring circuit, receiving the power supply voltage, and generating a reset signal according to the power supply voltage and a comparison threshold; and
a monitoring switch device, having a first end, a second end and a third end, wherein the first end receives the reset signal, the second end is coupled to the output terminal of the current-to-voltage conversion circuit, and the third end is coupled to the output end of the operational amplifier.

6. The current-to-voltage conversion circuit according to claim 5, wherein when the power supply voltage is less than the comparison threshold, the monitoring switch device is turned on, and the voltage regulation switch device is turned off; and/or
when the power supply voltage is greater than the comparison threshold, the monitoring switch device is turned off, and the voltage regulation switch device is turned on.

7. The current-to-voltage conversion circuit according to claim 5, wherein the monitoring switch device is a P-type field-effect transistor.

8. The current-to-voltage conversion circuit according to claim 5, wherein the power supply voltage has an output preset value, the comparison threshold is 80%×Vset-95%×Vset, wherein Vset is the output preset value.

9. The current-to-voltage conversion circuit according to claim 1, further comprising a current management circuit, the current management circuit comprises:
an input end, configured to receive a front-end current;
an output end, configured to provide an input current;
a current detection circuit having an input end, a first output end and a second output end, wherein the input end of the current detection circuit is coupled to the input end of the current management circuit, the first output end is coupled to the input terminal of the current-to-voltage conversion circuit so as to provide the input current, and the second output end outputs a current detection signal, wherein the current detection signal is configured to indicative of the magnitude of a current flowing through the current detection circuit;
a current control transistor, having a drain end, a gate end and a source end, wherein the drain end is coupled to the input end of the current management circuit, a gate end is configured to receive the current detection signal, and a source end is coupled to the reference ground;
a current control resistor, coupled between the second output end of the current detection circuit and the reference ground; and
wherein when the front-end current is smaller than the front-end threshold, the current control transistor is turned off; and when the front-end current is greater than the front-end threshold, the current control transistor is turned on.

10. The current-to-voltage conversion circuit according to claim 9, wherein the current detection circuit comprises a detection resistor and a voltage-to-current conversion circuit, wherein a voltage detection signal is generated according to a current flowing through the detection resistor, and the current detection signal is generated according to the voltage detection signal by the voltage-to-current conversion circuit.

11. The current-to-voltage conversion circuit according to claim 9, wherein the front-end threshold is related to the resistance of the current control resistor.

12. A digital isolator, comprising:
a current-to-voltage conversion circuit, wherein the current-to-voltage conversion circuit comprising:
an input terminal, configured to receive an input current;
an output terminal, configured to output a power supply voltage;
a voltage generation circuit having an input end and an output end, wherein the input end of the voltage generation circuit is coupled to the input terminal of the current-to-voltage conversion circuit so as to receive the input current and generate the power supply voltage according to the input current; and
a voltage regulation circuit, comprising an operational amplifier and a voltage regulation switch device, wherein a control end of the voltage regulation switch device is coupled to an output end of the operational amplifier;
wherein when the input current is less than an adjustment threshold, the voltage regulation switch device is turned off; and when the input current is greater than the adjustment threshold, the voltage regulation switch device is turned on;
a transmitting circuit, configured to generate a transmitting signal according to the power supply voltage;
an isolation circuit, configured to generate a receiving signal according to the transmitting signal; and
a receiving circuit, configured to generate an output voltage according to the receiving signal;
wherein the frequency of the transmitting signal is equal to the frequency of the receiving signal.

13. The digital isolator according to claim 12, wherein the voltage generation circuit comprising:
a first resistor having a first end and a second end, the first end of the first resistor is coupled to the input end of the voltage generation circuit to receive the input current;
a second resistor having a first end and a second end, the first end of the second resistor is coupled to the input end of the voltage generation circuit to receive the input current;
a third resistor having a first end and a second end, the first end of the third resistor is coupled to the second end of the first resistor, the second end of the third resistor is coupled to a reference ground;
a fourth resistor having a first end and a second end, the first end of the fourth resistor is coupled to the second end of the second resistor, the second end of the fourth resistor is coupled to the reference ground;
a fifth resistor having a first end and a second end, the second end of the fifth resistor is coupled to the reference ground;
a first transistor, wherein a drain end of the first transistor is coupled to the second end of the second resistor, and a source end of the first transistor is coupled to the first end of the fifth resistor; and
a second transistor, a gate end of the second transistor is coupled to a gate end of the first transistor, a drain end of the second transistor is coupled to the gate end of the second transistor and the second end of the first resistor, and a source end of the second transistor is coupled to the reference ground.

14. The digital isolator according to claim 13, wherein the adjustment threshold is related to the resistance of the first resistor.

15. The digital isolator according to claim 12, wherein the power supply voltage is between 1.2V and 2V.

16. The digital isolator according to claim 12, wherein current-to-voltage conversion circuit further comprising:
a power supply monitoring circuit, receiving the power supply voltage, and generating a reset signal according to the power supply voltage and a comparison threshold; and
a monitoring switch device, having a first end, a second end and a third end, wherein the first end receives the reset signal, the second end is coupled to the output terminal of the current-to-voltage conversion circuit, and the third end is coupled to the output end of the operational amplifier.

17. The digital isolator according to claim 16, wherein when the power supply voltage is less than the comparison threshold, the monitoring switch device is turned on, and the voltage regulation switch device is turned off; and/or
when the power supply voltage is greater than the comparison threshold, the monitoring switch device is turned off, and the voltage regulation switch device is turned on.

18. The digital isolator according to claim 12, wherein current-to-voltage conversion circuit further comprises a current management circuit, the current management circuit comprising:
an input end, configured to receive a front-end current;
an output end, configured to provide an input current;
a current detection circuit having an input end, a first output end and a second output end, wherein the input end of the current detection circuit is coupled to the input end of the current management circuit, the first output end is coupled to the output terminal of the current-to-voltage conversion circuit so as to provide the input current, and the second output end outputs a current detection signal, wherein the current detection signal is configured to indicative of the magnitude of a current flowing through the current detection circuit;
a current control transistor, having a drain end, a gate end and a source end, wherein the drain end is coupled to the input end of the current management circuit, a gate end is configured to receive the current detection signal, and a source end is coupled to the reference ground;
a current control resistor, coupled between the second output end of the current detection circuit and the reference ground; and
wherein when the front-end current is smaller than the front-end threshold, the current control transistor is turned off; and when the front-end current is greater than the front-end threshold, the current control transistor is turned on.

19. The digital isolator according to claim 18, wherein the current detection circuit comprises a detection resistor and a voltage-to-current conversion circuit, wherein a voltage detection signal is generated according to a current flowing through the detection resistor, and the current detection signal is generated according to the voltage detection signal by the voltage-to-current conversion circuit.

20. The digital isolator according to claim 18, wherein the front-end threshold is related to the resistance of the current control resistor.
